(19) United States
(12) Patent Application Publication
(10) Pub. No.: US 2018/0245003 A1
(43) Pub. Date: Aug. 30, 2018

(54) FISCHER-TROPSCH PROCESS

(71) Applicant: SHELL OIL COMPANY, Houston, TX (US)

(72) Inventors: Johan Peter DEN BREEJEN, Amsterdam (NL); Alexander Petrus VAN BAVEL, Amsterdam (NL); Peter John VAN DEN BRINK, Amsterdam (NL)

(73) Assignee: Shell Oil Company, Houston, TX (US)

(21) Appl. No.: 15/756,252

(22) PCT Filed: Sep. 1, 2016
(86) PCT No.: PCT/EP2016/070615

§ 371 Date: Feb. 28, 2018

(30) Foreign Application Priority Data
Sep. 4, 2015 (EP) 15183835.6

(51) Int. Cl. C10G 2/00; B01J 21/06; B01J 23/75; B01J 37/18

(52) U.S. Cl. CPC C10G 2/332; C10G 2/341; B01J 21/063; C10G 2300/705; B01J 37/18; C10G 2300/4031; B01J 23/75

(57) ABSTRACT

The invention relates to a method for start-up and operation of a Fischer-Tropsch reactor comprising the steps of: providing a reactor with a fixed bed of Fischer-Tropsch catalyst precursor that comprises cobalt as catalytically active metal; supplying an initial hydrogen containing gaseous feed stream to the reactor, at a reduction temperature and pressure; supplying a further gaseous feed stream comprising carbon monoxide and hydrogen to the reactor; converting carbon monoxide and hydrogen supplied with the second gaseous feed stream to the reactor into hydrocarbons at a reaction temperature, wherein the reaction temperature is set at a value of at least 200° C. and hydrocarbons are produced.

### FIELD OF THE INVENTION

The present invention relates to a method for start-up and operation of a Fischer-Tropsch reactor.

### BACKGROUND TO THE INVENTION

The Fischer-Tropsch process can be used for the conversion of synthesis gas into liquid and/or solid hydrocarbons. The synthesis gas may be obtained from hydrocarbonaceous feedstock in a process wherein the feedstock, e.g. natural gas, associated gas and/or coal-bed methane, heavy and/or residual oil fractions, coal, biomass, is converted in a first step into a mixture of hydrogen and carbon monoxide. This mixture is often referred to as synthesis gas or syngas. The synthesis gas is then fed into a reactor where it is converted in one or more steps over a suitable catalyst at elevated temperature and pressure into paraffinic compounds and water in the actual Fischer-Tropsch process. The obtained paraffinic compounds range from methane to high molecular weight modules. The obtained high molecular weight modules can comprise up to 200 carbon atoms, or, under particular circumstances, even more carbon atoms. Numerous types of reactor systems have been developed for carrying out the Fischer-Tropsch reaction. For example, Fischer-Tropsch reactor systems include fixed bed reactors, especially multi-tubular fixed bed reactors, fluidised bed reactors, such as entrained fluidised bed reactors and fixed fluidised bed reactors, and slurry bed reactors such as three-phase slurry bubble columns and ebulated bed reactors.

Catalysts used in the Fischer-Tropsch synthesis often comprise a carrier-based support material and one or more metals from Group 8-10 of the Periodic Table of Elements, especially from the cobalt or iron groups, optionally in combination with one or more metal oxides and/or metals as promoters selected from zirconium, titanium, chromium, vanadium and manganese, especially manganese. Such catalysts are known in the art and have been described for example, in the specifications of WO 9700231A and U.S. Pat. No. 4,595,703.

One of the limitations of a Fischer-Tropsch process is that the activity of the catalyst will, due to a number of factors, decrease over time. The activity of the catalyst is decreased as compared to its initial catalytic activity. The initial activity of the catalyst can be its activity when fresh prepared. A catalyst that shows a decreased activity after use in a Fischer-Tropsch process is sometimes referred to as deactivated catalyst, even though it usually still shows activity. Sometimes such a catalyst is referred to as a deteriorated catalyst. Sometimes it is possible to regenerate the catalyst. This may be performed, for example, with one or more oxidation and/or reduction steps.

After regeneration, catalysts often show an activity that is lower than the activity of fresh prepared catalysts. Especially after multiple regenerations, it often proofs hard to regain an activity level comparable to the activity of fresh prepared catalysts. In order to be able to use a catalyst for a long time, it thus may be desirable to start a Fischer-Tropsch process with a fresh catalyst that has a relatively high activity.

The use of fresh or rejuvenated catalysts with a relatively high initial activity may have disadvantages. This may especially be the case when the amount of catalyst used in a reactor tube is fixed after loading of the catalyst in the reactor tube. One example of a reactor tube filled with a fixed amount of catalyst is a reactor tube filled with a packed bed of catalyst particles.

In a Fischer-Tropsch process with a catalyst with a relatively high initial activity, the activity of the catalyst is especially high at the start of the process. And, due to the high activity of the catalyst, a lot of water is produced in the Fischer-Tropsch hydrocarbon synthesis, resulting in a high relative humidity at the start of the Fischer-Tropsch process. During Fischer-Tropsch synthesis the relative humidity in a reactor tube may increase to such a level that it accelerates the deactivation of the catalyst during use. During start-up of a Fischer-Tropsch reactor with a very active catalyst, the reaction temperature is typically kept at a relatively low value, e.g. below 200° C., in order to avoid a too high product yield and accompanying high temperature rise due to the exothermic reaction. Without wishing to be bound to any theory, it is believed that especially the combination of relatively low temperature and a relatively high yield results in a high relative humidity in the reactor and therewith in undesired irreversible catalyst deactivation.

### SUMMARY OF THE INVENTION

It is an object of the present invention to provide an improved Fischer-Tropsch process in which a cobalt catalyst is used that has a relatively high initial activity.

It has now been found that the conditions of relative humidity and therewith of increased catalyst deactivation at the start-up of a Fischer-Tropsch reactor can be avoided by supplying a nitrogen-containing compound to the catalyst precursor or catalyst prior to the initial stages of operation of the Fischer-Tropsch reactor. By supplying a nitrogen-containing compound to the catalyst precursor prior to the initial stages of operation, the catalyst activity is decreased and the temperature can be increased. Such conditions of higher temperature and decreased activity result in a lower relative humidity and less catalyst deactivation. Moreover, since the effect of such nitrogen-containing compound on catalyst activity seems to be reversible, the catalyst activity can be tuned by adjusting the concentration of the nitrogen-containing compound. With reversible is meant that at least part of the effect of the nitrogen compounds on the catalyst may be undone. In particular, the gradual decrease in catalyst activity can be compensated by gradually decreasing the concentration of the nitrogen-containing compound in the feed gas stream supplied to the catalyst. Thus, reaction temperature and reactor productivity (yield) can be controlled and kept constant during a relatively long period after start-up of the reactor, resulting in improved catalyst stability.

A method for start-up and operation of a Fischer-Tropsch reactor comprising the steps of:

(a) providing a reactor with a fixed bed of Fischer-Tropsch catalyst precursor that comprises cobalt as catalytically active metal;

(b) supplying an initial hydrogen containing gaseous feed stream to the reactor, at a reduction temperature and pressure;

(c) supplying a further gaseous feed stream comprising carbon monoxide and hydrogen to the reactor;

(d) converting carbon monoxide and hydrogen supplied with the second gaseous feed stream to the reactor into hydrocarbons at a reaction temperature, wherein the reaction temperature is set at a value of at least 200° C. and hydrocarbons are produced; and

wherein a nitrogen containing compound is provided to the fixed bed:
in step b) together with the initial hydrogen containing gaseous feed stream; and/or
After completion of step (b) but preceding supplying the further gaseous feed stream.

An important advantage of the method of the invention is that a higher reaction temperature is allowed in the initial phase of the operation of the reactor, compared to the initial reaction temperature in a reactor wherein no nitrogen-containing compound is supplied with the feed gas stream, resulting in a lower relative humidity.

Another advantage is that by tuning the amount of nitrogen-containing compound, the reaction temperature and/or the yield can be controlled. It has further been found that the selectivity for C5+ hydrocarbons is not importantly affected by the higher reaction temperature during start-up and initial phase of operation of the reactor.

Another advantage of the method according to the invention is that, compared to start-up methods wherein a relatively low initial temperature is used to avoid a too high yield and water production of the reactor at or shortly after start-up, heat recovery from the process is improved, since steam of a higher quality can be produced.

### DETAILED DESCRIPTION OF THE INVENTION

The method according to the present invention is a method for start-up and operation of a Fischer-Tropsch reactor. The method comprises the steps of:

(a) providing a reactor with a fixed bed of Fischer-Tropsch catalyst precursor that comprises cobalt as catalytically active metal;

(b) supplying an initial hydrogen containing gaseous feed stream to the reactor, at a reduction temperature and pressure;

(c) supplying a further gaseous feed stream comprising carbon monoxide and hydrogen to the reactor;

(d) converting carbon monoxide and hydrogen supplied with the second gaseous feed stream to the reactor into hydrocarbons at a reaction temperature, wherein the reaction temperature is set at a value of at least 200° C. and hydrocarbons are produced.

Steps (a) and (b) are steps preceding the start of the reactor. Step (b) is an activation step in which a catalyst precursor is reduced to its catalytically active state. Reference herein to a catalyst precursor is to a precursor that can be converted into a catalytically active catalyst by subjecting the precursor to reduction, usually by subjecting the precursor to hydrogen or a hydrogen-containing gas using reducing conditions.

After activation of the catalyst the gaseous feed stream is changed to a gaseous feed stream comprising hydrogen and carbon monoxide (referred to as synthesis gas or syngas) starting the reactor (step (c) and (d)). For the present invention with starting the reactor is meant the start of the Fischer-Tropsch synthesis.

The method according to the invention comprises the step of providing a nitrogen containing compound to the fixed bed:
in step b) together with the initial hydrogen containing gaseous feed stream; and/or
After completion of step (b) but preceding supplying the further gaseous feed stream (syngas).

With completion of step b) is meant that a sufficient amount of catalyst precursor has been reduced to its catalytically active form and preferably substantially all catalyst precursor has been reduced to its catalytically active form.

Hence in a method according to the present invention the nitrogen containing compound is provided prior to the start of the synthesis of hydrocarbons.

Once the reactor is provided with a fixed bed by reduction of the Fischer-Tropsch catalyst precursor in step (b), Fischer-Tropsch hydrocarbon synthesis is started in steps (c) and (d) by supplying a gaseous feed stream comprising carbon monoxide and hydrogen to the reactor. The gaseous feed stream may be supplied to the reactor at any suitable gas hourly space velocity. In step (d) carbon monoxide and hydrogen in the gaseous feed stream supplied to the reactor are converted into hydrocarbons at a suitable reaction pressure and at an initial reaction temperature.

In an aspect of the invention the nitrogen containing compound is provided to the fixed bed catalyst only:
in step b) together with the initial hydrogen containing gaseous feed stream; and/or
After completion of step (b) but preceding supplying the further gaseous feed stream in step (c). The present inventors have found that in order to achieve one or more of the objects of the invention no further nitrogen containing compounds have to be provided during steps (c) and (d). In an aspect no nitrogen containing compound is added in the further gas stream (syngas) of step (c) and (d).

In an aspect of the invention the provision of catalyst precursor in step (a) comprises the step of:
Oxidizing a fixed bed catalyst having a decreased activity due to the conversion of carbon monoxide and hydrogen into hydrocarbons, at a temperature between 20 and 400° C.

Hence, in this aspect of the invention an activated used catalyst is rejuvenated. Used catalysts may have a decreased activity due to the conversion of carbon monoxide and hydrogen into hydrocarbons. Hence the catalyst has been deactivated or partly deactivated by use in a Fischer-Tropsch process.

Reference herein to a rejuvenated catalyst is to a regenerated catalyst of which the initial activity has been at least partially restored, typically by means of several reduction and/or oxidation steps. Rejuvenation may be effected in the reactor in which the catalyst has been used or may be effected outside of the reactor by first removing the used catalyst from the reactor and having the catalyst subjected to a rejuvenation process.

In an aspect of the invention the catalyst precursor of step (a) is a fresh catalyst precursor. Fresh catalysts obtained from fresh catalyst precursor have a very high initial activity. The disadvantages of fresh catalysts at the start of the synthesis process have been mentioned earlier and the present invention provides for a solution to these disadvantages. With fresh catalyst and fresh catalyst precursor is meant a catalyst or catalyst precursor which has not been used before in hydrocarbon synthesis.

The reduction in step (b) may be conducted at a pressure in the range from 0.5 to 100 bar and preferably at a pressure of 10 to 90 bar. The initial gaseous feed stream may be provided for a period of time ranging from 5 to 240 hours. In an aspect of the invention the gas hourly space velocity at which the method is performed ranges from 100 to 10000 hr−1.

In an aspect of the present invention the initial gas stream is obtained from off gas from a Fischer-Tropsch reactor. The gaseous hydrocarbon stream exiting a Fischer-Tropsch reactor during operation is often referred to as Fischer-Tropsch off-gas. Fischer-Tropsch off-gas can be recycled to the syngas manufacturing or to the Fischer-Tropsch reactor. An ingredient of Fischer-Tropsch off-gas is hydrogen. Hydrogen is one of the most valued products and recovery thereof is economically advantageous. Hence the hydrogen recovered from the off gas can be used in step (b).

In an aspect of the invention the initial gaseous feed stream consists substantially of a nitrogen containing compound and hydrogen. The inventors have found that in case substantially pure hydrogen is used good results are obtained with respect to reduction and managing the catalyst activity during start-up.

In an aspect of the present invention the nitrogen-containing compound is a compound selected from the group consisting of nitrogen, ammonia, HCN, NO, an amine and combinations thereof, preferably the nitrogen containing compound is ammonia.

The content of the nitrogen containing compound, other than N2, in the initial gaseous feed stream may be up to 1000 ppmV and preferably may be from 0.1 to 100 ppmV based on the initial gas stream volume. In case N2 is used in during the reduction, N2 may be present in an amount of up to 25 vol % and preferably 20 vol % based on the total volume of the initial gas stream. The inventors have found that good results are obtained within these ranges.

The present invention provides a use of nitrogen or a nitrogen containing compound during in situ reduction of a Fischer-Tropsch cobalt catalyst precursor for reversibly reducing the activity of a cobalt catalyst. The present inventors have found that the use of nitrogen or a nitrogen containing compound reversibly reduces the activity at the initial stages of hydrocarbon synthesis. As explained the catalyst activity is decreased and the temperature can be increased at the initial stages of hydrocarbon synthesis (at the start of step (c)). Such conditions of higher temperature and decreased activity result in a lower relative humidity and less catalyst deactivation. The inventors have observed that the effect of nitrogen or nitrogen containing compounds is reversible.

A Fischer-Tropsch catalyst or catalyst precursor comprises a catalytically active metal or precursor therefor, and optionally promoters, supported on a catalyst carrier.

The activated catalyst comprises cobalt as catalytically active metal. Fischer-Tropsch catalysts comprising cobalt as catalytically active metal are known in the art. Any suitable cobalt-comprising Fischer-Tropsch catalysts known in the art may be used. Typically such catalyst comprises cobalt on a carrier-based support material, optionally in combination with one or more metal oxides and/or metals as promoters selected from zirconium, titanium, chromium, vanadium and manganese, especially manganese. A most suitable catalyst comprises cobalt as the catalytically active metal and titania as carrier material.

The catalyst may further comprise one or more promoters. One or more metals or metal oxides may be present as promoters, more particularly one or more d-metals or d-metal oxides. Suitable metal oxide promoters may be selected from Groups 2-7 of the Periodic Table of

Elements, or the actinides and lanthanides. In particular, oxides of magnesium, calcium, strontium, barium, scandium, yttrium, lanthanum, cerium, titanium, zirconium, hafnium, thorium, uranium, vanadium, chromium and manganese are suitable promoters. Suitable metal promoters may be selected from Groups 7-10 of the Periodic Table of Elements. Manganese, iron, rhenium and Group 8-10 noble metals are particularly suitable as promoters, and are preferably provided in the form of a salt or hydroxide.

The promoter, if present in the catalyst, is typically present in an amount of from 0.001 to 100 parts by weight per 100 parts by weight of carrier material, preferably 0.05 to 20, more preferably 0.1 to 15. It will however be appreciated that the optimum amount of promoter may vary for the respective elements which act as promoter.

If the catalyst comprises cobalt as the catalytically active metal and manganese and/or vanadium as promoter, the cobalt: (manganese+vanadium) atomic ratio is advantageously at least 12:1.

The catalyst carrier preferably comprises titania, preferably porous titania. Preferably more than 70 weight percent of the carrier material consists of titania, more preferably more than 80 weight percent, most preferably more than 90 weight percent, calculated on the total weight of the carrier material. As an example of a suitable carrier material can be mentioned the commercially available Titanium Dioxide P25 ex Evonik Industries. The carrier preferably comprises less than 40 wt % rutile, more preferably less than 30 wt %, even more preferably less than 20 wt %.

The synthesis gas is provided in step (c) and (d) and can be provided by any suitable means, process or arrangement. This includes partial oxidation and/or reforming of a hydrocarbonaceous feedstock as is known in the art. To adjust the H2/CO ratio in the syngas, carbon dioxide and/or steam may be introduced into the partial oxidation process. The H2/CO ratio of the syngas is suitably between 1.5 and 2.3, preferably between 1.6 and 2.0.

The syngas comprising predominantly hydrogen, carbon monoxide and optionally nitrogen, carbon dioxide and/or steam is contacted with a suitable catalyst in the catalytic conversion stage, in which the hydrocarbons are formed. Suitably at least 70 v/v % of the syngas is contacted with the catalyst, preferably at least 80%, more preferably at least 90%, still more preferably all the syngas.

A steady state catalytic hydrocarbon synthesis process may be performed under conventional synthesis conditions known in the art. Typically, the catalytic conversion may be effected at a temperature in the range of from 100 to 600° C., preferably from 150 to 350° C., more preferably from 175 to 275° C., most preferably 200 to 260° C. Typical total pressures for the catalytic conversion process are in the range of from 5 to 150 bar absolute, more preferably from 5 to 80 bar absolute. In the catalytic conversion process mainly C5+ hydrocarbons are formed.

A suitable regime for carrying out the Fischer-Tropsch process with a catalyst comprising particles with a size of least 1 mm is a fixed bed regime, especially a trickle flow regime. A very suitable reactor is a multitubular fixed bed reactor. A multitubular reactor comprises several reactor tubes. These tubes are provided with catalyst particles or precursors thereof. These tubes are typically made of metal.

References to “Groups” and the Periodic Table as used herein relate to the new IUPAC version of the Periodic

Table of Elements such as that described in the 87th Edition of the Handbook of Chemistry and Physics (CRC Press).

The invention is illustrated by the following non-limiting examples.

### EXAMPLES

### Experiment 1

In one experiment a Co-titania catalyst (catalyst A) was reduced at 10 bar, 280° C. and GHSV 500 h−1. After ramping up in nitrogen to 280° C., nitrogen and hydrogen were exchanged in 50 h followed by 24 h at 100% H2. Subsequently, at the same temperature and pressure the gas was switched to 90% H2 and 10% N2 and the flow stopped for 10 h.

As a reference experiment a similar reduction was conducted (10 bar, 280° C.). However, this time the pressure was lowered after 75 h reduction to 1 bar, and a flow of pure hydrogen was applied for 48 h.

The results are depicted in FIG. 1 in a graph. In the graph, the activity factor is plotted as function of time for catalyst A where the reduction was ended with a gas stream comprising 10% N2 and 90% H2 (10 bar, 280° C.) The open triangles show the ammonium concentration (right axis) in produced water. The dotted black line represents the reference run (10 bar, 280° C.)

The aqueous effluent for catalyst A was analyzed for the ammonium content. The found values are indicated by the triangles in FIG. 1. It clearly can be observed that the activity increases with time. This is accompanied with a decrease in ammonium content in the water phase. This shows the reversible nature of the reduction in activity and likely the presence of adsorbed NHx species or cobalt nitride formation during the reduction.

### Experiment 2

In Experiment 2 a cobalt catalyst was given a 10 bar reduction for 75 h (see Example 1). During the entire reduction a 33 ppmV NH3 was co-fed with the reduction gas.

Directly after completion of the reduction step syngas was fed to the catalyst. As can be seen in FIG. 2, a slow start-up was achieved, and an extended dwell at a H2/N2 flow was not required.

### Experiment 3

In experiment 3 one catalyst (reference) was reduced with either 100% H2 (FIG. 3A, interrupted line) or 80% H2/20% N2 (FIG. 3A, solid line) throughout the whole experiment after which syngas was provided to the catalysts. FIG. 3A shows the vol % of H2 provided during the reduction. The activity factor was determined of each of the catalysts (see FIG. 3 B). The interrupted line indicates the activity factor of the catalyst reduced with 100% H₂ and the solid line of the catalyst reduced with 80%H2/20% N2.

Clearly an initial sedation effect is seen for the catalyst reduced with 80% H2 throughout the whole reduction, compared to the catalyst reduced with 100% hydrogen from t=55 h onwards.

While the invention has been described in terms of what are presently considered to be the most practical and preferred embodiments, it is to be understood that the disclosure need not be limited to the disclosed embodiments. It is intended to cover various modifications, combinations and similar arrangements included within the spirit and scope of the claims, the scope of which should be accorded the broadest interpretation so as to encompass all such modifications and similar structures. The present disclosure includes any and all embodiments of the following claims.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes.

Any patents, publications, or other references mentioned in this application for patent are hereby incorporated by reference. In addition, as to each term used, it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans.

1. A method for start-up and operation of a Fischer-Tropsch reactor comprising the steps of:
(a) providing a reactor with a fixed bed of Fischer-Tropsch catalyst precursor that comprises cobalt as catalytically active metal;
(b) supplying an initial hydrogen containing gaseous feed stream to the reactor, at a reduction temperature and pressure;
(c) supplying a further gaseous feed stream comprising carbon monoxide and hydrogen to the reactor;
(d) converting carbon monoxide and hydrogen supplied with the second gaseous feed stream to the reactor into hydrocarbons at a reaction temperature, wherein the reaction temperature is set at a value of at least 200° C. and hydrocarbons are produced; and
wherein a nitrogen containing compound is provided to the fixed bed:
in step b) together with the initial hydrogen containing gaseous feed stream; and/or
After completion of step (b) but preceding supplying the further gaseous feed stream.

2. A method according to claim 1, wherein the nitrogen containing compound is provided to the fixed bed catalyst only:
in step b) together with the initial hydrogen containing gaseous feed stream; or
After completion of step (b) but preceding supplying the further gaseous feed stream in step (c).

3. A method according to claim 1, wherein the provision of catalyst precursor in step (a) comprises the step of:
Oxidizing a fixed bed catalyst having a decreased activity due to the conversion of carbon monoxide and hydrogen into hydrocarbons, at a temperature between 20 and 400° C.

4. A method according to claim 1, wherein the catalyst precursor of step (a) is a fresh catalyst.

5. A method according to claim 1, wherein no nitrogen containing compound is present in the further gas stream.

6. A method according to claim 1, wherein the reduction temperature ranges from 200° C. to 500° C.

7. A method according to claim 1, wherein the pressure in step b) is in the range from 0.5 to 100 bar.

8. Method A method according to claim 1, wherein the initial gaseous feed stream is provided for a period of time ranging from 5 to 240 hours.

9. A method according to l claim 1, wherein the content of the nitrogen containing compound, other than N2, in the initial gaseous feed stream is up to 1000 ppmV and preferably 0.1 to 100 ppmV.

10. A method according to claim 1, wherein the initial gaseous feed stream consists of nitrogen containing compound and hydrogen.

11. A method according to claim 1, wherein the nitrogen-containing compound is a compound selected from the group consisting of ammonia, HCN, NO, an amine and combinations thereof preferably, at least ammonia is selected and more preferably the nitrogen-containing compound is ammonia

12. A method according to claim 1, wherein the nitrogen containing compound is provided in step b) and is present in hydrogen containing gaseous feed stream until completion of step b).

13. A method according to claim 1, wherein at the start of step b) the hydrogen containing gaseous feed stream comprises substantially no nitrogen containing compound and preferably the nitrogen containing compound is added to the hydrogen containing gaseous feed stream after the start of step b) preferably the nitrogen containing compound is added to the hydrogen containing gaseous feed stream such that the nitrogen content increases over time till preferably 20 vol % based on the total feed stream.

14. A cobalt catalyst prepared with nitrogen or a nitrogen containing compound during in situ reduction of a Fischer-Tropsch cobalt catalyst precursor for reversibly reducing the activity of the cobalt catalyst.
